(19) United States
(12) Patent Application Publication
(10) Pub. No.: US 2026/0249323 A1
(43) Pub. Date: Aug. 27, 2026

(54) DRIVE EXCITER AND ELECTRONIC DEVICE

(71) Applicant: Goertek Inc., Weifang, Shandong (CN)

(72) Inventors: Tomokuni Wauke, Shandong (CN); Haiyang Ding, Shandong (CN); Hiroyuki Kobayashi, Shandong (CN)

(73) Assignee: Goertek Inc., Weifang, Shandong (CN)

(21) Appl. No.: 18/870,738

(22) PCT Filed: Nov. 4, 2022
(86) PCT No.: PCT/CN2022/130008

§ 371 Date: Dec. 2, 2024

(30) Foreign Application Priority Data
May 31, 2022 (CN) 202210609355.5

(51) Int. Cl. B06B 1/04; B06B 1/02; G06F 3/01; H02K 7/06

(52) U.S. Cl. CPC B06B 1/045; B06B 1/0207; G06F 3/016; H02K 7/06; B06B 2201/53

(57) ABSTRACT

The present disclosure discloses a drive excitation apparatus and an electronic device. The drive excitation apparatus includes an even number of drive exciters, and the drive exciter includes an outer shell, a vibration part, a braking part and a latch part; the vibration part is movably provided in the excitation space formed by the outer shell, and is provided with a vibration member capable of vibrating along a first direction; the braking part is fixed in the excitation space along the first direction; and the latch part includes a driving member connected to the housing and a latch member connected to the driving member. The drive exciter has a first state where the latch member abuts against the vibration part and a second state where the latch member is disengaged from the vibration part; in the first state, the even number of outer shells are connected sequentially along the first direction, vibration members of two adjacent drive exciters vibrate in opposite directions, and the even number of drive exciters sequentially enter the second state; in the second state, the vibration part moves towards the braking part and abuts against the braking part.

### CROSS-REFERENCE TO RELATED APPLICATIONS

The present disclosure is a National Stage of International Application No. PCT/CN2022/130008, filed on Nov. 4, 2022, which claims priority to a Chinese patent application No. 202210609355.5 filed with the CNIPA on May 31, 2022, both of which are hereby incorporated by reference in their entireties.

### TECHNICAL FIELD

The present disclosure relates to the technical field of a vibration apparatus, and particularly to a drive excitation apparatus and an electronic device.

### BACKGROUND

A traditional vibration apparatuses produces an illusion of a force “seemingly directed in a certain direction” by continuously producing asymmetric vibrations. However, to create this illusion, not only does the skin need to undergo shear deformation, which restricts the way the device can be held, but it is also necessary to limit the vibration frequency to a perceptible range, and the stimulation must be continued for a period of time. Equivalent force felt in this way is small, and the excess vibration also makes it difficult for the user to get a clear sense of direction.

As a means of reproducing force sensations, there is a method for obtaining anisotropic vibration by releasing the fixed state of the movable vibration part by braking. However, when the vibrating part is fixed, it continuously vibrates and accelerates, causing excess vibration to escape from the outer shell and generating slight noise, which affects the vibration effect and user experience of the generated anisotropic vibration to a certain extent.

The above content is provided solely to assist in understanding the technical solution of the present disclosure and does not constitute an admission that the above content is prior art.

### SUMMARY

The main objective of the present disclosure is to provide a drive excitation apparatus, intended to suppress excess vibrations leaking from an outer shell while discretely presenting clear and distinct anisotropic vibrations.

To achieve the above objective, the present disclosure proposes a drive excitation apparatus. The drive excitation apparatus includes an even number of drive exciters, and each of the drive exciters includes:
an outer shell forming an excitation space;
a vibration part movably provided in the excitation space and provided with a vibration member capable of vibrating along a first direction;
a braking part fixed in the excitation space along the first direction and provided facing towards the vibration part; and
a latch part including a driving member connected to the outer shell and a latch member connected to an output end of the driving member;
the drive exciter has a first state where the latch member abuts against the vibration part and a second state where the latch member is disengaged from the vibration part;
in the first state, the even number of outer shells are connected sequentially along the first direction, vibration members of two adjacent drive exciters vibrate in opposite directions, and the even number of drive exciters sequentially enter the second state; in the second state, the vibration part moves towards the braking part and abuts against the braking part.

In one embodiment of the present disclosure, the even number of vibration members have their centers coaxially arranged.

In one embodiment of the present disclosure, the outer shell includes:
a shell body, the even number of shell bodies being connected sequentially along the first direction; and
a bracket provided in the excitation space and including an installation member and a guiding structure connected to the installation member, the installation member being connected to at least one side of the shell body along the first direction, the braking part and the latch part being connected to the installation member, and the vibration part being movably connected to the guiding structure.

In one embodiment of the present disclosure, the vibration part includes:
a housing connected to the guiding structure and enclosing a vibration space, the vibration member being provided vibratably in the vibration space;
two elastic members provided on both sides of the vibration member along the first direction, and connected to the housing and the vibration member; and
two groups of magnetic members fixed in the vibration space and provided on opposite sides of the vibration member perpendicular to the first direction, each group of magnetic members, on a side thereof facing towards the vibration member, being provided with opposite magnetic poles;
the vibration member is provided with a coil;
in the first state, the coils of two adjacent drive exciters have opposite current directions.

In one embodiment of the present disclosure, the vibration part further includes a first yoke plate and a second yoke plate, which are provided opposite to each other and fixedly connected to the housing;
the elastic member is a spring leaf, with one end of the spring leaf connected to the first yoke plate or the second yoke plate, and the other end of the spring leaf connected to an end of the vibration member.

In one embodiment of the present disclosure, the bracket further includes a first connection rack provided parallel to the guiding structure, the first connection rack being connected to the installation member, and the driving member being fixed to the first connection rack;
the driving member is provided with a rotation shaft, with the latch member being a locking rod, one end of the latch member being connected to the rotation shaft, and a length direction of the latch member being arranged at an angle with an extension direction of the rotation shaft.

In one embodiment of the present disclosure, the latch part further includes a limiting member, which is connected to the first connection rack and forms a limiting groove, a sidewall of the limiting groove being formed with a notch facing towards the vibration part, one end of the latch member connected to the driving member extending into the limiting groove, one end of the latch member away from the driving member protruding out of the notch, and the latch member being rotated between two opposite sidewalls of the notch.

In one embodiment of the present disclosure, the guiding structure includes at least two guiderods extending along the first direction, ends of which being fixed to the installation member, the vibration part further includes a housing provided with at least two shaft liners, with one of the shaft liners being movably sleeved onto one of guiderods.

In one embodiment of the present disclosure, the installation member includes:
an installation body provided with an installation groove and a clearance hole provided on a bottom wall of the installation groove, the guiding structure being connected to the installation body; and
a coverplate sealing a rabbet of the installation groove and removably connected to the installation body, the braking part being fixedly connected to the coverplate through the clearance hole.

In one embodiment of the present disclosure, the latch part includes two latch members, which are located on both sides of the vibration part to form a limiting space, and the driving member is connected to at least one of the latch members;
wherein in the first state, the vibration part is limited in the limiting space.

In one embodiment of the present disclosure, each of the drive exciters includes two braking parts and two latch parts;
the two braking parts are fixed on two opposite sides of the vibration part along the first direction;
each of the latch parts includes one driving member and one latch member, two latch members being provided respectively on two sides of the vibration part along the first direction, and each latch member being provided between the vibration part and the braking part to form a limiting space;
wherein in the first state, the vibration part is limited in the limiting space.

In one embodiment of the present disclosure, the drive exciter further includes a resetting member which is a spring, with two ends of the spring elastically connected to the vibration part and the outer shell respectively;
and/or, an end of the vibration part along the first direction is provided with a cushioning member facing towards the braking part.

In one embodiment of the present disclosure, the braking part is a spring;
or, the braking part is rubber;
or, the braking part is foam;
or, the braking part is composed of at least two of the spring, rubber, and foam connected in series or in parallel.

The present disclosure further relates to an electronic device, which includes the drive excitation apparatus according to any one of the above embodiments.

The technical solution of the present disclosure may significantly increase the asymmetry of the anisotropic vibrations and present asymmetric vibrations discretely over a short period of time. Moreover, by generating vibrations that are close to the asymmetrical vibration force that actually occurs, it is possible to discretely present a clear force sensation in a certain direction for a short period of time, and the direction of this force sensation depends on the direction in which the braking part abuts against the vibration part, and is no longer limited to the manner of holding.

In addition, the drive excitation apparatus of the present disclosure employs an even number of connected drive exciters, and by the reverse vibration of the vibration members of the two adjacent drive exciters, it is possible to eliminate the unnecessary vibration generated in the energy storage stage, such that the anisotropic vibrations generated by the drive excitation apparatus are purer, thus improving the running quality and the user's experience of the drive excitation apparatus.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings can also be obtained according to the disclosed drawings without creative efforts.

FIG. 1 is a schematic structural diagram of one embodiment of the drive exciter according to the present disclosure;

FIG. 2 is a sectional diagram of one embodiment of the drive exciter according to the present disclosure;

FIG. 3 is a partial schematic structural diagram of one embodiment of the drive exciter according to the present disclosure;

FIG. 4 is a schematic structural diagram of a vibration part of one embodiment of the drive exciter according to the present disclosure;

FIG. 5 is partial schematic structural diagram in another perspective of the vibration part in FIG. 4;

FIG. 6 is a schematic structural diagram of an installation part of another embodiment of the drive exciter according to the present disclosure;

FIG. 7 is a schematic structural diagram of an energy storage stage of one embodiment of the drive exciter according to the present disclosure;

FIG. 8 is a schematic structural diagram of a releasing stage of one embodiment of the drive exciter according to the present disclosure;

FIG. 9 is a schematic structural diagram of a motion stage of one embodiment of the drive exciter according to the present disclosure;

FIG. 10 is a schematic structural diagram of a braking stage of one embodiment of the drive exciter according to the present disclosure;

FIG. 11 is a schematic structural diagram of a returning stage of one embodiment of the drive exciter according to the present disclosure;

FIG. 12 is a schematic structural diagram of one embodiment of the drive exciting apparatus according to the present disclosure;

FIG. 13 is a waveform diagram of an asymmetric signal of one embodiment in the prior art;

FIG. 14 is a waveform diagram of an asymmetric signal of another embodiment in the prior art;

FIG. 15 is a waveform diagram of a vibration signal of a single drive exciter;

FIG. 16 is a waveform diagram of a vibration signal of one embodiment of the drive exciting apparatus according to the present disclosure;

FIG. 17 is a signal timing diagram of a vibration signal of one embodiment of the drive exciting apparatus according to the present disclosure.

### DESCRIPTION OF REFERENCE SIGNS

| No. | Name | No. | Name |
|---|---|---|---|
| 1000 | drive excitation apparatus | 34 | first yoke plate |
| 100 | first drive exciter | 35 | second yoke plate |
| 10 | bracket | 36 | magnetic member |
| 11 | installation member | 37 | spring leaf |
| 111 | installation body | 39 | cushioning member |
| 111a | clearance hole | 40 | braking part |
| 113 | coverplate | 50 | latch part |
| 13 | guiding structure | 51 | driving member |
| 131 | guiderod | 53 | latch member |
| 15 | first connection rack | 55 | limiting member |
| 17 | second connection rack | 55a | limiting groove |
| 30 | vibration part | 55b | notch |
| 31 | housing | 60 | resetting member |
| 311 | shaft liner | 200 | second drive exciter |
| 33 | vibration member | | |

The realization of the purpose, functional features and advantages of the present disclosure will be further described in conjunction with the embodiments and with reference to the accompanying drawings.

### DETAILED DESCRIPTION

Technical solutions in the embodiments of the present disclosure are described below with reference to the accompanying drawings in the embodiments of the present disclosure. Apparently, the described embodiments are merely some rather than all of the embodiments of the present disclosure. All other embodiments, acquired by those of ordinary skill in the art based on the embodiments of the present disclosure without any creative work, should fall into the protection scope of the present disclosure.

It should be noted that all directional indications (such as up, down, left, right, front, rear . . . ) in the embodiments of the present disclosure is only used to explain the relative position relationship between the components under a particular attitude (as shown in the attached drawing), the motion, etc., and if the specific attitude changes, the directional indication will change accordingly.

In addition, descriptions involving “first”, “second”, etc., in the present disclosure are used solely for descriptive purposes and should not be construed as indicating or implying their relative importance or as implicitly specifying the number of the indicated technical features. Thus, features defined by “first”, “second”, etc., may explicitly or implicitly include at least one such feature. Furthermore, technical solutions from different embodiments can be combined, but must be based on what an ordinary skilled person in the art could achieve. When the combination of technical solutions results in mutual contradictions or impossibility of implementation, such combinations should be considered non-existent and outside the scope of protection claimed in the present disclosure.

The so-called “anisotropic vibration”, also known as “asymmetric vibration” creates a sensation for the user holding the vibration device of being pulled in a specific direction by inputting an asymmetrical signal to the vibration apparatus such as a vibration motor, etc. Moreover, vibration apparatuses capable of achieving anisotropic vibration are commonly used in devices such as game controllers and provide users with excellent force feedback through asymmetric vibration.

In the vibration apparatus involved in the technical solution of the present disclosure, the so-called “discrete” is a concept that contrasts with “continuous”. For example, the vibration motor continuously vibrates to output a continuous vibration to the vibration apparatus, such that the user feels a vibration or pulling sensation that lasts for a period of time, it is referred to as the continuous vibration; however, if the vibration apparatus outputs a clear vibration directed toward a specific direction once or multiple times at intervals over a period, it is referred to as the discrete anisotropic vibration.

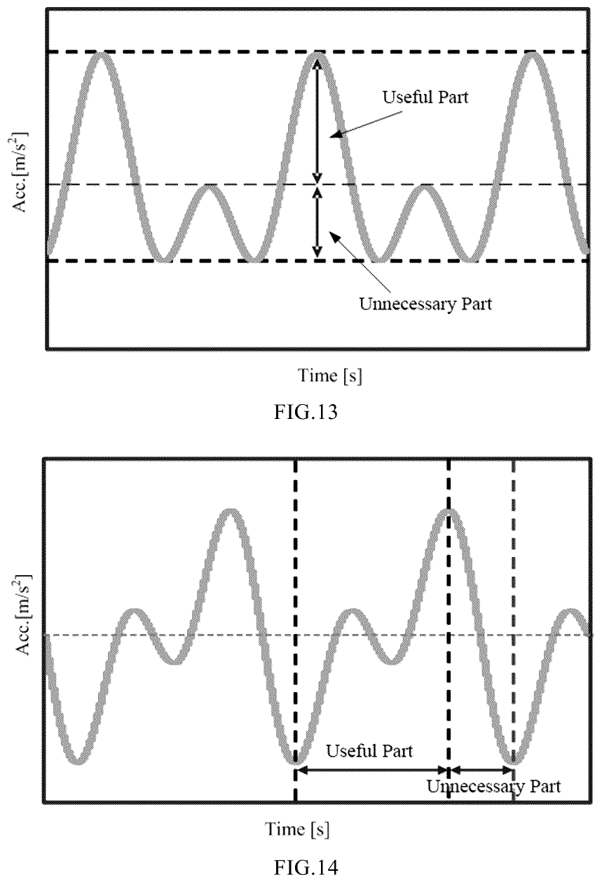

However, as shown in FIGS. 13 and 14, both figures illustrate that the waveform repeats in a certain cycle. This is because the pseudo-force sensation effect of “pulling in a certain direction” is generated through an asymmetric waveform that repeats at a constant period. Clearly, in addition to the part of the waveform that contributes to generating the force sensation, there are many unnecessary vibrations, making this method unsuitable for producing discrete force sensations.

Referring to FIGS. 1 to 17, the present disclosure proposes a drive excitation apparatus 1000. The drive excitation apparatus 1000 includes an even number of drive exciters, each of the drive exciters includes an outer shell, a vibration part 30, a braking part 40 and a latch part 50. The outer shell forms an excitation space, the vibration part 30 is movably provided in the excitation space and provided with a vibration member 33 capable of vibrating along a first direction. The braking part 40 is fixed in the excitation space along the first direction and provided facing towards the vibration part 30. The latch part 50 includes a driving member 51 connected to a housing 31 and a latch member 53 connected to an output end of the driving member 51. The drive exciter has a first state where the latch member 53 abuts against the vibration part 30 and a second state where the latch member 53 is disengaged from the vibration part 30. In the first state, the even number of outer shells are connected sequentially along the first direction, and the vibration members 33 of two adjacent drive exciters vibrate in opposite directions. The even number of drive exciters sequentially enter the second state, where the vibration part 30 moves towards the braking part 40 and abuts against the braking part 40.

As shown in FIG. 15, the third waveform from the top in the figure represents the vibration signal. The portion framed by the dashed line indicates the residual vibration generated when the vibration part 30 is fixed in the first state. Thereafter, it represents the anisotropic vibration generated when the vibration part 30 in the second state is braked by the braking part 40, clearly showing that the signal of the residual vibration still has considerable intensity compared to the signal of the anisotropic vibrations.

To suppress excess vibrations leaking from the outer shell while discretely presenting clear and distinct anisotropic vibrations, in the present disclosure, the even number of outer shells are connected sequentially along the first direction, and the vibration members 33 of two adjacent drive exciters vibrate in opposite directions.

Specifically, in one embodiment, the first direction is the horizontal direction, and the excitation space has a certain length in the first direction, which may allow the braking part 40 to be fixed in the excitation space along the first direction and enable the vibration part 30 to move a certain distance along the first direction. The vibration part 30 may be a linear resonator, and inside the vibration part 30, there is a vibration member 33 that vibrates in a certain direction. It can be understood that the vibration member 33 has a certain mass to possess sufficient energy during vibration.

The vibration part 30 may be fitted with a clearance fit relative to the inner wall of the excitation space, or the outer shell may be provided with a guiding structure 13 therein, and the vibration part 30 may be slidably connected to the guiding structure 13 for more stable movement.

In the present embodiment, the latch part 50 is provided on a side of the vibration part 30, wherein the drive member 51 may be a linear motor, solenoid, linear actuator, rotary motor, or other drive device, and drives the latch member 53 to approach or move away from the vibration part 30 either by translation or rotation.

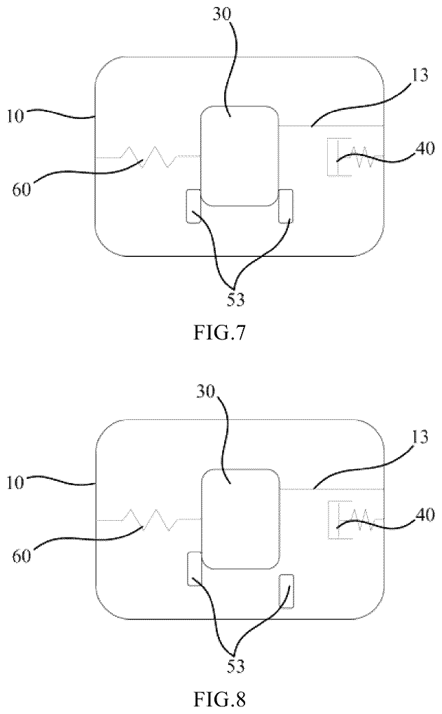

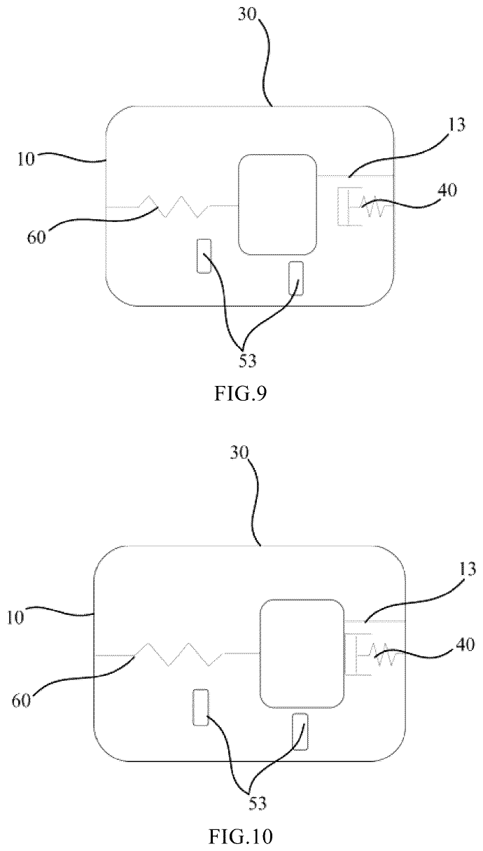

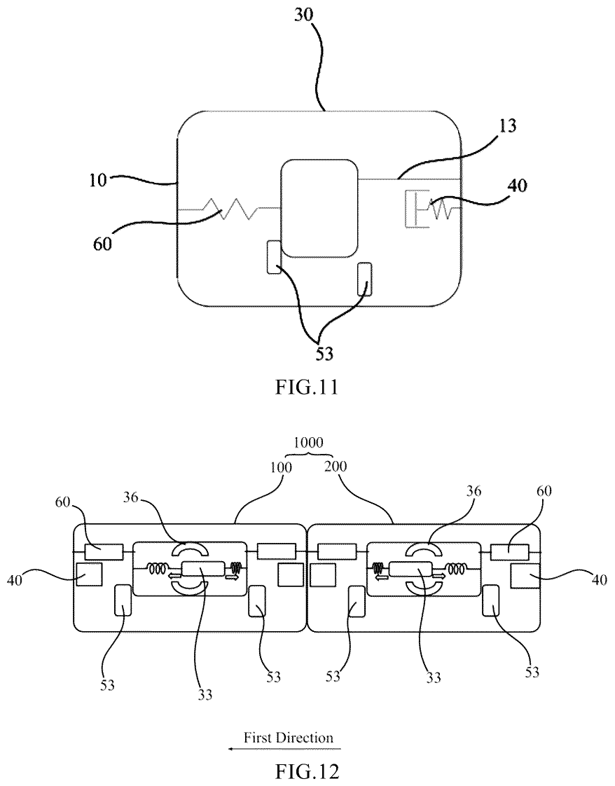

Referring to FIGS. 7 to 17 in combination, it is necessary for the drive exciter to go through the following stages to produce a complete anisotropic vibration:
energy storage stage: referring to FIG. 7, inputting an electric drive signal to the vibration part 30, generating an excitation magnetic field or electric field in the vibration chamber so as to drive the vibration member 33 to accelerate the vibration continuously for storing energy, and at this point the drive exciter is in the first state, and the latch member 53 abuts against the side surface of the vibration part 30 to relatively fix the vibration part 30 in the vibration direction of the vibration part 33;
releasing stage: referring to FIG. 8, the drive member 51 drives the latch member 53 to translate or rotate until the latch member 53 is disengaged from the vibration part 30, causing the drive exciter 100 to enter the second state;
motion stage: referring to FIG. 9, at this point, the drive exciter is in the second state. The vibration part 30 is disengaged from the constraint of the latch member 53 and, under the drive of the internal vibration part 33, moves towards the braking part 40 provided on the installation member 11;
braking stage: referring to FIG. 10, the vibration part 30 abuts against the braking part 40, the braking part 40 receives the energy produced by the vibration of the vibration member 33, thereby producing the anisotropic vibrations and generating a pulling sensation or force sensation along a normal direction of the contact surface between them;
returning stage: referring to FIG. 11, after the anisotropic vibration is generated once, the vibration part 30 leaves the braking part 40, and the drive exciter returns to the first state and waits for the next trigger, at which point the anisotropic vibration stops.

It can be understood that in the above embodiment, the generation of the anisotropic vibration does not originate from the vibration of the vibration part 30 itself, but rather from the cooperation between the braking part 40 and the vibration part 30. Specifically, the braking part 40 brakes the vibration part 30 to generate the anisotropic vibration, and after the vibration part 30 leaves the braking part 40, the vibration gradually decreases and stops.

After going through the above stages, the drive exciter may generate the anisotropic vibration once. Repeating the above processes multiple times within a certain period may discretely generate multiple instances of anisotropic vibration. Further, by controlling the motion frequency of the vibration part 30, it is possible to control the frequency of generating the anisotropic vibration. By changing parameters such as the mass of the vibration part 30 or the magnitude of the current, it is possible to change the amount of energy stored in the energy storage stage of the vibration part, thereby changing the intensity of anisotropic vibrations.

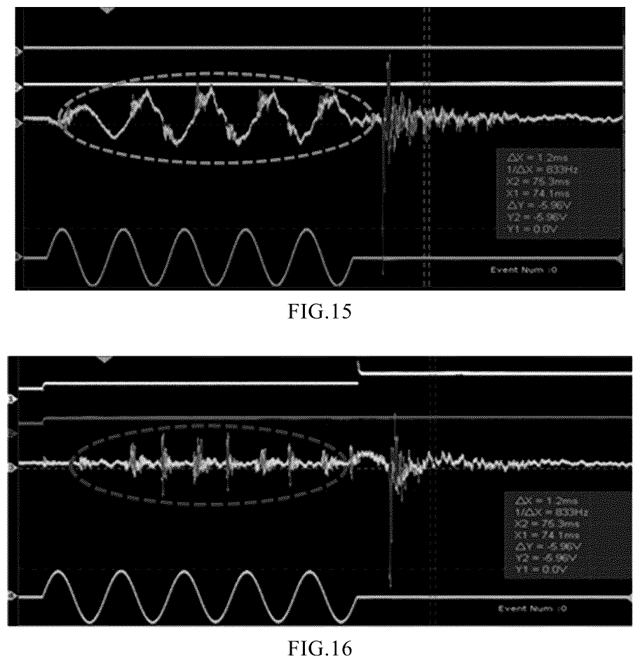

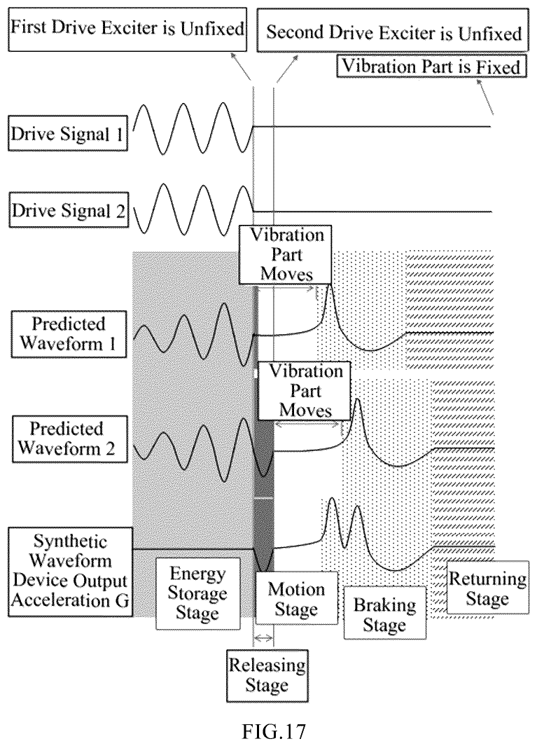

Here, in one embodiment, the drive excitation apparatus includes two connected drive exciters. During the energy storage stage, since the vibration members 33 of the two drive exciters move in opposite directions, the unnecessary vibrations during the energy storage stage may be canceled out. Specifically, please refer to FIGS. 15 and 16, the third waveform from the top in FIG. 15 represents the vibration waveform when a single drive exciter is active. Similarly, FIG. 16 shows the vibration waveform under the technical solution of the present embodiment. The portions framed by the dashed lines in both figures represent the vibration waveforms during the energy storage stage. By comparing these two figures, it is clear that when the technical solution of the present disclosure is used, the residual vibrations during the energy storage stage are effectively suppressed.

Furthermore, referring to FIG. 17, the anisotropic vibrations in the present embodiment are generated as follows:
the drive signal represents the phase state of the excitation signal that drives the vibration member 33 of the vibration part 30, the drive signals of the first drive exciter 100 and the second drive exciter 200 have the same period but are out of phase by half a cycle, and thus the vibration members 33 of the two drive exciters vibrate in opposite directions. As the drive signal continues to be input, the energy possessed by the vibration members 33 gradually increases. Under ideal conditions, the synthetic waveform of the two vibration members 33 vibrating in opposite directions is approximately a straight line. When being accelerated to a certain degree, the drive signal is cut off, and the first drive exciter 100 and the second drive exciter 200 sequentially enter the second state with a time difference of about half a cycle, so as to ensure that when the vibration part 30 abuts against the braking part 40, the first drive exciter 100 and the second drive exciter 200 may generate co-directional anisotropic vibrations. Subsequently, the two vibration parts 30 are sequentially braked by their corresponding braking parts 40 so as to generate two anisotropic vibrations approximately half a cycle apart in phase. When the period is sufficiently short, these two anisotropic vibrations may be perceived as a single distinct vibration.

The technical solution of the present disclosure, by providing the latch member 53 movably, enables the drive exciter to switch between the first state and the second state, wherein in the first state, the vibration part 30 is relatively fixed; in the second state, the vibration part 30 abuts against the braking part 40, and the braking part 40 brakes the vibration part 30 to generate unidirectional vibration. Since the generation of these anisotropic vibrations requires the cooperation of the braking part 40 and the vibration part 30, the frequency of generating the vibrations depends on how often the vibration part 30 moves and abuts against the braking part 40, and thus when the latch member 53 continuously moves to switch between the first state and the second state, the vibration part 30 abuts against the braking part 40 intermittently, and thus it is possible to generate the anisotropic vibrations discretely.

The technical solution of the present disclosure can significantly increase the asymmetry of the anisotropic vibrations and present asymmetric vibrations discretely over a short period of time. Moreover, by generating vibrations that are close to the asymmetrical vibration force that actually occurs, it is possible to discretely present a clear force sensation in a certain direction for a short period of time, and the direction of this force sensation depends on the direction in which the latch member 53 abuts against the vibration part 30, and is no longer limited to the manner of holding.

In addition, the drive excitation apparatus 1000 of the present disclosure employs an even number of connected drive exciters, and by the reverse vibration of the vibration members of the two adjacent drive exciters, it is possible to eliminate the unnecessary vibrations generated in the energy storage stage, such that the anisotropic vibrations generated by the drive excitation apparatus are purer, thus improving the running quality and the user's experience of the drive excitation apparatus 1000.

Referring to FIG. 12, in one embodiment of the present disclosure, centers of the even number of vibration members 33 are coaxially arranged. In one embodiment, the drive excitation apparatus includes a first drive exciter 100 and a second drive exciter 200. The first drive exciter 100 and the second drive exciter 200 have identical internal structures, and each of the drive exciters includes one vibration part 30, two braking parts 40 on two sides, and a latch part 50. The first drive exciter 100 and the second drive exciter 200 are connected along the first direction, with their outer shells abutting or adhering to each other. Of course, the connection method is not limited, as long as it can transmit vibrations.

At the same moment, the two vibration members 33 either move towards each other or away from each other, with their centers lying on the same straight line. This allows the vibrations generated by the two members cancel each other out more thoroughly, achieving better suppression of unnecessary vibrations during the energy storage stage.

Similarly, in some other embodiments of the present disclosure, the drive excitation apparatus 1000 may be provided with four, eight, or even more drive exciters, with the vibration members 33 of pairs of drive exciters moving in opposite directions at the same moment.

In embodiments of other aspects of the present disclosure, when the drive excitation apparatus 1000 is provided with more drive exciters, a plurality of vibration members 33 may be staggered, or partially coaxial and partially staggered, so as to achieve a variety of vibration effects.

Referring to FIGS. 1 and 12, in one embodiment of the present disclosure, the outer shell includes a shell body and a bracket 10; the even number of shell bodies are connected sequentially along the first direction. The bracket 10 is provided in the excitation space and includes an installation member 11 and a guiding structure 13 connected to the installation member 11. The installation member 11 is connected to at least one side of the shell body along the first direction. The braking part 40 and the latch part 50 are connected to the installation member 11, and the vibration part 30 is movably connected to the guiding structure 13.

In the present embodiment, the shape of the housing 31 is not limited, and the excitation space formed by the housing 31 is sufficient to support the vibration part 30 to move for a certain distance to impact the braking part. The installation member 11 is generally plate-shaped, and one surface thereof is fixedly connected to an inner wall of the housing 31. The guiding structure 13 is provided on one side of the installation member 11 and is fixedly connected to it. The vibration part 30 is movably connected to the guiding structure 13. The braking part 40 is fixed to the surface of the installation member 11 facing towards the vibration part 30. The guiding structure 13 may be provided around the braking part 40 or may be provided on one side of the guiding part, which is not limited herein.

Optionally, the guiding structure 13 may be one or more guiderods 131 connected to the installation member 11, and the vibration part 30 is sleeved onto the guiderod 131. Alternatively, the guiding structure 13 may be provided with a track groove, with the vibration part 30 slidably provided inside the track groove. By providing the installation member 11 and the guiding structure 13 to provide structural support and guidance for the braking part 40 and the limiting part, the internal structure of the driving exciter is more stable, and the movement of the vibration part 30 is smoother and faster.

Referring to FIGS. 1, 4 and 5, in one embodiment of the present disclosure, the vibration part 30 includes a housing 31, two elastic members 37 and two groups of magnetic members 36, the housing 31 is connected to the guiding structure 13 and encloses a vibration space, and the vibration member 33 is provided vibratably in the vibration space; two elastic members 37 are provided on both sides of the vibration member 33 along the first direction, and are connected to the housing 31 and the vibration member 33; and two groups of magnetic members 36 are fixed in the vibration space and provided on opposite sides of the vibration member 33 perpendicular to the first direction, and each group of magnetic members 36, on a side thereof facing towards the vibration member 33, is provided with opposite magnetic poles; the vibration member 33 is provided with a coil; in the first state, the coils of two adjacent drive exciters have opposite current directions.

In the present embodiment, the housing 31 includes two end caps arranged oppositely and a connecting plate provided between the two end caps. Each end cap is provided with two mounting lugs provided symmetrically or on the same side, and the mounting lug is provided with a clearance hole for the guiderod 131 to pass through. The mounting lugs of the two end caps are facing to each other and connected through the shaft liner 311.

The vibration part 33 vibrates in a certain direction within the vibration space. As the vibration part 33 vibrates, it simultaneously drives the elastic member 37 to vibrate and stores the generated energy in the elastic member 37. When the housing 31 abuts against the braking part 40, the stored energy is released to the braking part 40 to generate the vibration wave. Since the vibration part 30 abuts against the braking part 40 from one side, the resulting vibration is also one-sided and exhibits significant asymmetry. That is to say, pulling sensation in a certain direction is real and does not depend on the user's grip and sensory experience.

Referring to FIG. 12, in the present embodiment, each group of magnetic members 36 may be an independent roughly “U” shaped permanent magnet. The poles of two ends of the permanent magnet facing towards the vibration member 33 are opposite, and the poles of the surfaces of the two groups of permanent magnets facing towards each other are also opposite. When the coil is energized to generate a magnetic field, the vibration member 33 moves in a certain direction due to the interaction between the magnetic poles. It can be understood that when the current direction changes, the direction of the magnetic field generated by the coil also changes, consequently altering the movement direction of the vibration member 33. Therefore, when the current directions in the coils of the vibration members 33 of two adjacent drive exciters are opposite, the movement directions of the vibration members 33 are also opposite.

Of course, each group of magnetic members 36 may also include two permanent magnets, with the poles of the surfaces of the two permanent magnets facing towards the vibration member 33 being opposite.

In another embodiment, a coil is fixed in the vibration space, and the vibration member 33 is embedded with a permanent magnet. When the coil is energized and generates a magnetic field, the vibration member 33 vibrates under the influence of the magnetic field. When the current direction changes, the movement direction of the vibration member 33 also changes.

The driving method of the vibration of the vibration member 33 is not limited to the above embodiment, as long as the movement direction of the vibration member 33 can be regularly and periodically changed while the vibration member 33 is driven to move, and there is no further limitation.

In one embodiment of the present disclosure, the vibration part 30 further includes a first yoke plate 34 and a second yoke plate 35, which are provided opposite to each other and fixedly connected to the housing 31; the elastic member 37 is a spring leaf, with one end of the spring leaf connected to the first yoke plate 34 or the second yoke plate 35, and the other end of the spring leaf connected to an end of the vibration member 33.

Optionally, referring to FIG. 5, the vibration part 33 of the present embodiment has a substantially parallelogram cross section. The first direction is defined as the left-right direction, and the up-down direction, which is perpendicular to the first direction, lies within the paper plane. The first yoke plate 34 is provided at the top, the second yoke plate 35 is provided at the bottom. The upper left end of the vibration part 33 is connected to the second yoke plate 35, and the lower right end of the vibration part 33 is connected to the first yoke plate 34. When the vibration part 33 vibrates, its end drives the spring leaf to vibrate. This configuration allows better use of the elasticity of the spring leaf, thereby increasing the amplitude of the vibration part 33 and the spring leaf under the same conditions.

Referring to FIG. 1, in one embodiment of the present disclosure, the bracket 10 further includes a first connection rack 15 provided parallel to the guiding structure 13. The first connection rack 15 is connected to the installation member 11, and the driving member 51 is fixed to the first connection rack 15. The driving member 51 is provided with a rotation shaft, and the latch member 53 is a locking rod. One end of the latch member 53 is connected to the rotation shaft, and a length direction of the latch member 53 is arranged at an angle with an extension direction of the rotation shaft.

In the present embodiment, the first connecting rack 15 is bolted to the surface of the installation member 11 and has a length direction. The length direction of the first connecting rack 15 is parallel to the first direction. The latch member 53 and the drive member 51 are both connected to the side surface of the first connecting rack 15. Further, to reduce the structural weight and ensure the vibration effect, the first connecting rack 15 is partially hollowed out.

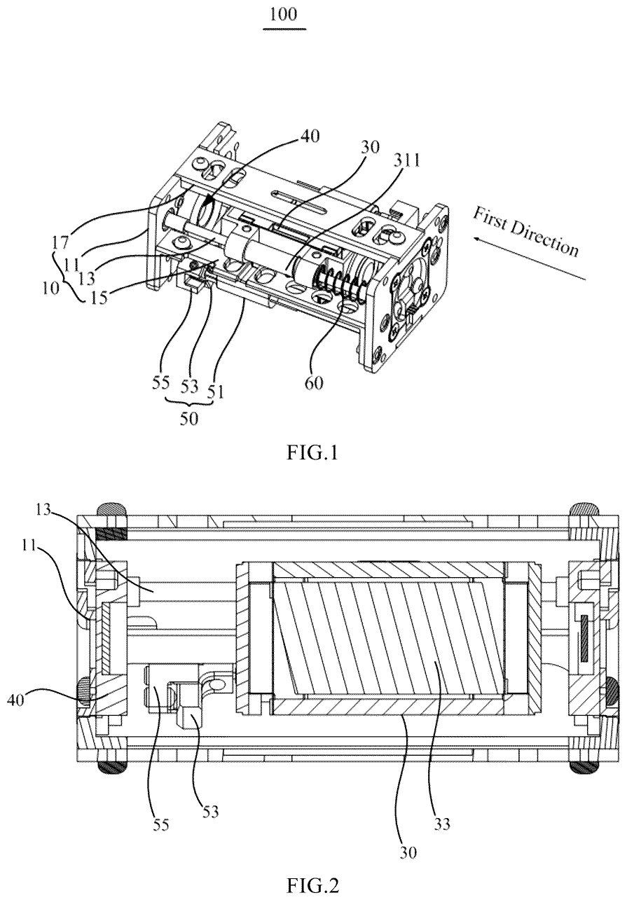

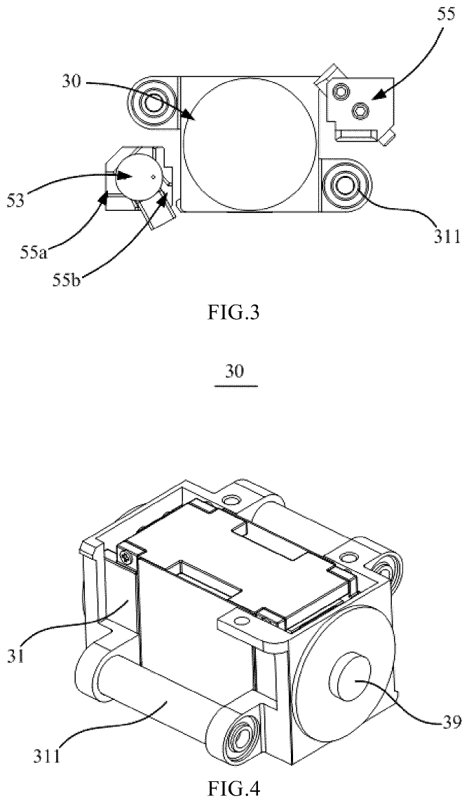

Optionally, referring to FIGS. 2 and 3, in the present embodiment, the drive member 51 is a rotating motor, the latch member 53 is a substantially L-shaped structural member. One branch of the latch member 531 is connected to the rotation shaft, and the rotation shaft rotates to enable the other branch of the latch member 53 to approach or be away from the vibration part 30. When the drive member 51 receives a designated signal, the rotation shaft drives the latch member 53 to rotate, until the latch member 53 abuts against the housing of the vibration part 30 or the latch member 53 is disengaged from the vibration part 30. Thus, it is possible to This configuration allows simple and convenient movement of the latch member 53 and the switching between the first state and the second state.

However, in the embodiment of other aspects of the present disclosure, the drive member 51 drives the latch member 53 to move linearly, and a motion direction of the latch member 53 is provided at an angle with the first direction. Optionally, the drive member 51 may be a linear motor and includes a stator and a rotor. The stator is fixed in the bracket 10, and the rotor is in sliding fit with the stator and moves along a straight line. The latch member 53 is connected to the rotor. Preferably, the straight line in which the motion direction of the latch member 53 is set at an angle of 90 degrees to the straight line where the vibration direction of the vibration member 33 is located. This arrangement is simple and effective, making the generation and transmission of vibrations more explicit and achieving good results.

Of course, the drive member 51 may also be other structures that can realize the above technical concept, which is not specifically limited. Accordingly, the structure of the latch member 53 may be modified based on the structure or spatial arrangement of the drive member 51, and is not limited.

Referring to FIGS. 2 and 3, in one embodiment of the present disclosure, the latch part 50 further includes a limiting member 55, the limiting member 55 is connected to the first connecting rack 15 and forms a limiting groove 55a. A sidewall of the limiting groove 55a is formed with a notch 55b facing towards the vibration part 30. One end of the latch member 53 connected to the drive member 51 extends into the limiting groove 55a, the other end of the latch member 53 away from the drive member 51 protrudes out of the notch 55b. The latch member 53 is rotated between two opposing sidewalls of the notch 55b.

Referring to FIG. 3, the limiting member 55 is a structure similar to a bottle cap, with no specific limitations on its shape. A rabbet of the limiting groove 55a faces towards the latch member 53. In the present embodiment, the drive member 51 is a rotary motor. A part of the latch member 53 is provided within the limiting groove 55a, while another part passes through the notch 55b and protrudes out of the limiting groove 55a. It can be understood that the drive member 51 may drive the latch member 53 to rotate within the space between the two sidewalls of the notch 55b. When the latch member 53 abuts against one sidewall, it also just abuts against the vibration part 30; when the latch member 53 abuts against the other sidewall, it is disengaged from the vibration part 30. By additionally providing the limiting member 55 to restrict the movement range of the latch member 53, it helps to counteract the inertia of the latch member 53 to a certain extent, improving the working efficiency and stability of the latch member 53.

In one embodiment of the present disclosure, the guiding structure 13 includes at least two guiderods 131 extending along the first direction, with their ends fixed to the installation member 11. The vibration part 30 further includes a housing 31, which is provided with at least two shaft liners 311 at a side surface thereof, and one of the shaft liners 311 are movably sleeved onto one of guiderods 131. The guiderod 131 may be provided around the braking part 40 or may be provided on a side of the braking part 40. A bearing is provided in the shaft liner 311, and the vibration part 30 may move towards or away from the braking part 40 along the guiderod 131. The arrangement of the guiderod 131 may provide structural support and guidance for the limiting part, such that the internal structure of the drive exciter is more stable and the movement of the vibration part 30 is smoother and faster.

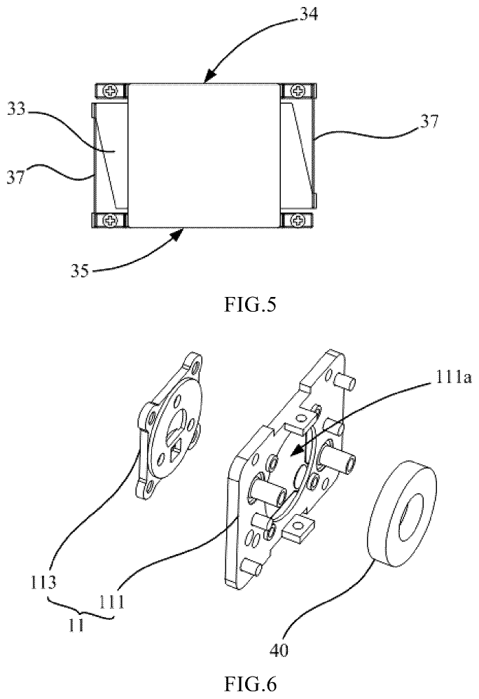

Further, referring to FIG. 6, in one embodiment of the present disclosure, the installation member 11 includes an installation body 111 and a coverplate 113. The installation body 111 is provided with an installation groove and a clearance hole 111a provided on a bottom wall of the installation groove. The guiding structure 13 is connected to the installation body 111, and the coverplate 113 seals a rabbet of the installation groove and is removably connected to the installation body 111. The braking part 40 is fixedly connected to the coverplate 113 through the clearance hole 111a. The coverplate 113 is bolted to the installation body 111, the braking part 40 is glued or bolted to the coverplate 113. The interaction between the vibration part 30 and the braking part 40 will inevitably cause wear and tear on the hardware. In the present embodiment, removing the coverplate 113 allows the replacement of braking part 40 or the maintenance of equipment, which is convenient and quick.

Referring to FIGS. 7 to 11, in one embodiment of the present disclosure, the latch part 50 includes two latch members 53, which are located on both sides of the vibration part 30 to form a limiting space. The driving member 51 is connected to at least one of the latch members 53. Here, in the first state, the vibration part 30 is limited in the limiting space. In the present embodiment, the latch member 53 may be a block-shaped entity or a rod-shaped entity. Optionally, the braking part 40 is provided on one side of the vibration member 33 along the first direction, and the two latch members 53 are provided at intervals to form the vibration space. That is to say, in the present embodiment, the drive exciter is provided with a braking part 40 arranged on one side, wherein the latch member 53 on one side is fixed, and the driving member 51 is connected to the latch member 53 on the other side and drives the latch member 53 to rotate or translate, so as to switch the drive exciter between the first state and the second state.

The combination of the vibration part 30 and the braking part 40 may generate anisotropic vibrations in one direction. When an even number of drive exciters are used in cooperation, the braking part 40 may be provided in the same direction or staggered in reverse to generate a variety of vibration effects.

For example, in one embodiment, the braking parts 40 of the even number of drive exciters are all arranged on one side of the interior thereof. When the drive exciters are sequentially excited, a plurality of vibrations in the same direction are generated. In another embodiment, the braking parts 40 of several drive exciters are arranged along one side of the first direction, and the braking parts 40 of other drive exciters are arranged on the other side. When the drive exciters are excited in turn, different vibrations in multiple directions are superimposed. Through calculation or control, a variety of vibrations with different durations, intensities and levels may be generated discretely under ideal conditions.

Referring to FIGS. 1 and 12, in another embodiment of the present disclosure, each of the drive exciters includes two braking parts 40 and two latch parts 50. The two braking parts 40 are fixed on two opposite sides of the vibration part 30 along the first direction. Each of the latch parts 50 includes one driving member 51 and one latch member 53. The two latch members 53 are provided respectively on two sides of the vibration part 30 along the first direction, and each latch member 53 is provided between the vibration part 30 and the braking part 40 to form a limiting space. In the first state, the vibration part 30 is limited in the limiting space.

In the present embodiment, at least one second connection rack 17 is provided between the two installation members 11, and ends of the second connection rack 17 are connected to the installation members 11 respectively, further ensuring structural stability. The latch member 53 is provided on one side of the driving member 51 along the first direction. When observing the drive exciter along the first direction, the two latch members 53 may be provided on the same side of the vibration part 30 or symmetrically on the opposite sides of the vibration part 30. Both latch members 53 are movable, but in the second state, only one of the latch members 53 moves and is disengaged from the vibration part 30. For example, the first direction is defined as the left-right direction, and when the right latch member 53 is moved, the left latch member 53 remains fixed, allowing the vibration part 30 to move to the right; conversely, when the left latch member 53 is moved, the right latch member 53 remains fixed, allowing the vibration part 30 to move to the left. In the second state, the vibration part 30 can only approach one of the braking parts 40, and the anisotropic vibrations generated by the vibration part 30 matching with the two braking parts 40, respectively, are opposite.

In other words, in the present embodiment, the drive exciter may achieve movement of the vibration part 30 in different directions, thereby presenting two anisotropic vibrations in opposite directions. It should be noted that the two vibrations mentioned above do not exist at the same time. When the even number of drive exciters are matched, by controlling the latch member 53 on the same side to open in turn or controlling the latch member 53 on the opposite side to open alternately, a variety of vibration effects can be achieved.

Optionally, the guiding structure 13 is the guiderod 131, and there may be provided a plurality of guiderods 131. The latch part 50 may also be provided in a plurality. The guiderod 131 and the latch part 50 are alternately provided in the circumferential direction of vibration part 30. This arrangement ensures that the latch members 53 provided on both sides in the vibration direction of the vibration part 30 are equal in number and symmetrically positioned, thereby ensuring uniform stress distribution and structural stability.

Referring to FIG. 1, in one embodiment of the present disclosure, the drive exciter further includes a resetting member 60, which is a spring. Two ends of the spring are elastically connected to the vibration part 30 and the outer shell, respectively. By providing the resetting member 60, the vibration part 30 can be smoothly reset after the braking stage, allowing the drive exciter to be restored to the first state. Of course, the resetting member 60 is not limited to a spring; it can also be other structures capable of resetting the vibration part 30.

Optionally, to protect the hardware and achieve good transmission of the vibration, an end of the vibration part 30 along the first direction is provided with a cushioning member 39 facing towards the braking part 40. The cushioning member 39 may be made of an elastic material such as rubber.

Optionally, in one embodiment of the present disclosure, the braking part 40 is a spring; or, the braking part 40 is rubber; or, the braking part 40 is foam; or, the braking part 40 is composed of at least two of a spring, rubber, and foam connected in series or in parallel. That is to say, two or three of the spring, rubber, and foam may be connected end-to-end sequentially to achieve good braking effects, or they may be provided in parallel to brake the vibration part 30 and ensure structural stability.

The braking part 40 may be additionally provided with two pressing plates, with the spring, rubber, and foam connected to the two pressing plates in parallel or in series. One pressing plate is connected to the outer shell, and the other pressing plate is used to abut against the vibration part 30. In this way, the braking part 40 can achieve good braking as well as the effect of absorbing and transmitting vibration.

The present disclosure also relates to an electronic device, which includes the drive excitation apparatus 1000 described in any of the above embodiments. The specific structure of the drive excitation apparatus 1000 refers to the above embodiments. Since the electronic device adopts all the technical solutions of the above embodiments, it therefore possesses all the beneficial effects brought by the technical solutions of the above embodiments, which will not be elaborated herein.

Here, in some applications of the drive excitation apparatus 1000, the electronic device may be a tactile device such as a handle or a VR all-in-one machine.

The above description is merely an optional embodiment of the present disclosure, and is not intended to limit the patent scope of the present disclosure. Any equivalent structural transformations made based on the inventive concept of the present disclosure using the contents of the specification and the accompanying drawings of the present disclosure, or their direct/indirect application in other related technical fields, shall fall within the scope of patent protection of the present disclosure.

1. A drive excitation apparatus, comprising an even number of drive exciters, wherein each of the drive exciters comprises:
an outer shell forming an excitation space;
a vibration part movably provided in the excitation space and provided with a vibration member configured for vibrating along a first direction;
a braking part fixed in the excitation space along the first direction and provided facing towards the vibration part; and
a latch part comprising a driving member connected to the outer shell and a latch member connected to an output end of the driving member;
wherein, the drive exciter has a first state where the latch member abuts against the vibration part and a second state where the latch member is disengaged from the vibration part; and
in the first state, the outer shells are connected sequentially along the first direction, two of the vibration members of two of the even number of adjacent drive exciters are configured to vibrate in opposite directions, and the of drive exciters are configured to sequentially enter the second state where the vibration part is configured to moves towards the braking part and abuts against the braking part.

2. The drive excitation apparatus according to claim 1, wherein each of the vibration members has a center thereof coaxially arranged.

3. The drive excitation apparatus according to claim 1, wherein the outer shell comprises:
a shell body, being connected sequentially along the first direction; and
a bracket provided in the excitation space and comprising an installation member and a guiding structure connected to the installation member, the installation member being connected to at least one side of the shell body along the first direction, the braking part and the latch part being connected to the installation member, and the vibration part being movably connected to the guiding structure.

4. The drive excitation apparatus according to claim 3, wherein the vibration part comprises:
a housing connected to the guiding structure and enclosing a vibration space, the vibration member being provided in the vibration space;
two elastic members provided on two sides of the vibration member along the first direction, and connected to the housing and the vibration member; and
two groups of magnetic members fixed in the vibration space and provided on opposite sides of the vibration member perpendicular to the first direction, each group of magnetic members being provided with opposite magnetic poles on a side thereof facing towards the vibration member;
the vibration member comprises a coil; and
in the first state, two coils of two adjacent drive exciters have opposite current directions thereof.

5. The drive excitation apparatus according to claim 4, wherein the vibration part further comprises a first yoke plate and a second yoke plate, which are provided opposite to each other and fixedly connected to the housing;
the elastic member comprises is a spring leaf, with a first end of the spring leaf connected to the first yoke plate or the second yoke plate, and a second end of the spring leaf connected to an end of the vibration member.

6. The drive excitation apparatus according to claim 3, wherein the bracket further comprises a first connection rack provided parallel to the guiding structure, the first connection rack being connected to the installation member, and the driving member being fixed to the first connection rack;
the driving member comprises a rotation shaft, with the latch member being a locking rod, one end of the latch member being connected to the rotation shaft, and a length direction of the latch member being arranged at an angle with an extension direction of the rotation shaft.

7. The drive excitation apparatus according to claim 6, wherein the latch part further comprises a limiting member, which is connected to the first connection rack to form a limiting groove, a sidewall of the limiting groove being formed with a notch facing towards the vibration part, one end of the latch member connected to the driving member extending into the limiting groove, one end of the latch member away from the driving member protruding out of the notch, and the latch member being rotated between two opposite sidewalls of the notch.

8. The drive excitation apparatus according to claim 3, wherein the guiding structure comprises at least two guiderods extending along the first direction, ends of which being fixed to the installation member, the vibration part further comprises a housing provided with at least two shaft liners, with one of the shaft liners being movably sleeved onto one of guiderods.

9. The drive excitation apparatus according to claim 3, wherein the installation member comprises:
an installation body provided with an installation groove and a clearance hole provided on a bottom wall of the installation groove, the guiding structure being connected to the installation body; and
a coverplate sealing a rabbet of the installation groove and removably connected to the installation body, the braking part being fixedly connected to the coverplate through the clearance hole.

10. The drive excitation apparatus according to claim 1, wherein the latch part comprises two latch members, which are located on both sides of the vibration part to form a limiting space, and the driving member is connected to at least one of the latch members;
wherein in the first state, the vibration part is limited in the limiting space.

11. The drive excitation apparatus according to claim 1, wherein each of the drive exciters comprises two braking parts and two latch parts;
the two braking parts are fixed on two opposite sides of the vibration part along the first direction;
each of the latch parts comprises one driving member and one latch member, two latch members being provided respectively on two sides of the vibration part along the first direction, and each latch member being provided between the vibration part and the braking part to form a limiting space;
wherein in the first state, the vibration part is limited in the limiting space.

12. The drive excitation apparatus according to claim 1, wherein the drive exciter further comprises a resetting member comprising a spring, with two ends of the spring elastically connected to the vibration part and the outer shell respectively; and/or
an end of the vibration part along the first direction is provided with a cushioning member facing towards the braking part.

13. The drive excitation apparatus according to claim 1, wherein the braking part comprises a spring; or
the braking part comprises rubber; or
the braking part comprises foam; or
the braking part comprises of at least two of the spring, rubber, and foam connected in series or in parallel.

14. An electronic device, comprising a drive excitation apparatus according to claim 1.
